(19) United States
(12) Patent Application Publication
(10) Pub. No.: US 2026/0120149 A1
(43) Pub. Date: Apr. 30, 2026

(54) ASYSTEM AND A METHOD FOR OPTIMIZING ADVERTISEMENT YIELD AND REDUCING ADVERTISEMENT LATENCY

(71) Applicant: Adster Technologies Pvt. Ltd., Bengaluru (IN)

(72) Inventors: Ketan Chandak, Bengaluru (IN); Ranganathan Srinivasan, Bengaluru (IN); Girish Vishwanath Chirravoori, Bengaluru (IN); Shivansh Pandey, Bengaluru (IN); Ashish Kumar, Bengaluru (IN); Rajiv Kumaar, Bengaluru (IN); Akshat Goyal, Bangalore (IN)

(21) Appl. No.: 19/406,121

(22) Filed: Dec. 2, 2025

Related U.S. Application Data
(63) Continuation of application No. 19/211,687, filed on May 19, 2025.
Application No. 19/211,687 is a continuation-in-part of application No. 18/926,743, filed on Oct. 25, 2024, now Pat. No. 12,307,480.

(51) Int. Cl. G06Q 30/0273

(52) U.S. Cl. CPC G06Q 30/0275

(57) ABSTRACT

A system and method reduce advertisement latency by executing a Software Development Kit (SDK) within a device-resident application. In response to an ad-placement request, the SDK simultaneously issues bid requests to (i) at least one mediation platform and (ii) multiple header-bidding partners (HBPs). The mediation platform is traversed through dynamically ordered floor-price groups until an ad fill is returned, allowing the SDK to infer an approximate mediation bid range from the group that produced the fill. In parallel, the SDK determines the highest HBP bid. Both the mediation-platform ad object and the HBP ad object—together with their respective bid information—are cached in volatile memory. The SDK then compares the highest HBP bid to an upper bound of the inferred mediation bid range, identifies the maximum bid, and instantly renders the cached ad object corresponding to that bid, thereby minimizing network latency while maximizing revenue.

### FIELD OF INVENTION

The present invention relates to digital advertising systems and, more specifically, to systems and methods for optimizing advertisement yield and reducing advertisement latency in real-time bidding environments.

### BACKGROUND

In the digital advertising industry, real-time bidding (RTB) has become the standard practice for optimizing ad revenue. Through RTB, advertisers can bid for ad impressions in real time, allowing publishers to maximize the value of their ad inventory. One widely adopted method in RTB is header bidding, where multiple demand partners are allowed to bid simultaneously for ad placements, ensuring greater competition for each impression and potentially higher yields for publishers.

In addition to header bidding, mediation platform, such as Google Ad Manager™ and AdMob™, are used by publishers to manage multiple ad networks. The mediation platform sends a parallel bid to demand partners that are integrated with them. For example, Meta™, PubMatic™, InMobi™ and others are called in parallel and a demand partner that sends the highest bid within the mediation platform wins the bid. Further, the winner platform sends an ad object to an application requesting the advertisement.

Despite these technological advancements, publishers face significant limitations in their ability to fully utilize these tools. Publishers often lack the infrastructure, such as their own ad servers, to manage demand sources effectively. They are restricted by the limitations of third-party platforms, which can create inefficiencies in integrating demand partners. These limitations prevent publishers from gaining the flexibility needed to maximize their ad yields.

However, while both header bidding and mediation platforms offer benefits, the combination of these systems often results in technical inefficiencies, particularly with respect to ad delivery speed.

Furthermore, as the digital advertising ecosystem evolves, major platforms like Google™ and Meta™ continue to introduce changes in response to new regulations and market demands. Publishers must constantly adapt their systems to remain compliant and competitive, creating additional complexity that further slows down the ad delivery process.

Latency becomes a critical issue in digital advertising because ad requests must be processed and ads must be delivered within a very short window of time. When ad requests are delayed due to slow response times from header bidding partners or mediation platforms, there is a high risk that the ad will not be served before the user navigates away from the page or app. This results in lost ad opportunities and lower ad fill rates, as the system is unable to deliver an ad in time.

Moreover, in traditional systems using waterfall architectures, ad requests are often handled sequentially, meaning that one demand source is queried at a time. Each demand source is evaluated in a set order, and if one does not fill the request, the system moves to the next source. This “sequential” process adds significant delays, which are further compounded by network hops between mediation platforms, header bidding partners, and ad networks.

The technical challenge lies in the multiple network hops required in traditional systems, where each interaction between the header bidding partners, mediation platforms, and ad networks adds to the total processing time. As a result, many ad opportunities are lost not because of a lack of bids, but because the system is too slow to complete the ad selection and delivery process within the available timeframe.

For publishers, this latency issue directly impacts revenue, as each lost ad opportunity reduces their ability to monetize their inventory effectively. Even publishers with large technology teams struggle to maintain optimal system performance as they face the increasing complexity of managing multiple demand sources. To solve these issues, a system is needed that integrates both client-side and server-side optimizations, allowing publishers to streamline ad delivery and improve yield.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for reducing advertisement latency is provided. The system includes a device including a processor and a memory executing an application, and a Software Development Kit (SDK) integrated with the application, stored in the memory and executed by the processor. The SDK is coupled to a publisher server and configured to receive an ad request for an ad placement, concurrently transmit bid requests to at least one mediation platform and to a plurality of header-bidding partners (HBPs), query the mediation platform through a plurality of floor groups until an advertisement fill is returned, identify an approximate mediation bid range by determining which floor group produced the fill, cache an HBP ad object associated with a highest HBP bid and a mediation ad object returned by the mediation platform for the advertisement fill, determine a maximum bid by comparing the highest HBP bid with the approximate mediation bid range, and select for display on the device the advertisement associated with the maximum bid.

According to other aspects of the present disclosure, the system may include one or more of the following features. The plurality of floor groups may be dynamically generated from effective cost-per-mille (eCPM) data. The SDK may adjust number and width of the plurality of floor groups according to historical eCPM distributions. The SDK may terminate further mediation queries once the highest HBP bid exceeds an upper bound of the approximate mediation bid range of the floor group that returned the fill. The SDK may record bid outcomes and bypass mediation partners with historically low win rates in subsequent ad requests. The system may further comprise determining, in real time, the highest HBP bid from the plurality of bids received from the plurality of header bidding partners. The maximum bid may be a winning bid amongst the plurality of bids from the plurality of header bidding partners and the one or more mediation partners. The concurrent bid requests may be additionally transmitted to a plurality of ad networks separate from the plurality of header-bidding partners and the at least one mediation platform. The system may further comprise retrieving ad placement details from a remote configuration, and the ad placement details may comprise a list of applicable ad partners and their supported ad types, configuration settings for at least one of series processing and parallel processing, and cache handling instructions. The caching of the mediation ad object and its approximate mediation bid range, and the HBP ad object and the highest HBP bid may be performed in volatile memory for immediately retrieving the ad object. The parallel bid requests may be initiated simultaneously across the mediation platform, header bidding partners, and a plurality of ad networks. The system may further comprise detecting a cache hit by determining whether the ad object associated with the maximum bid is already stored in the cache and, in response to the cache hit, retrieving and displaying the cached ad object. The system may further comprise utilizing the plurality of ad networks as backfill to fill the ad placement through waterfall architecture upon failure to receive bids from the plurality of header bidding partners and at least one mediation platform. The system may further comprise prioritizing backfill ad networks based on predefined criteria, such as historical fill rates, ad performance, or revenue potential, to optimize ad selection when the plurality of header bidding partners and mediation platform fail to provide an ad or a winning bid or an ad with a bid higher than a threshold ad bid decided by a client. The backfill ad networks may be prioritized according to predefined criteria that include at least one of historical fill rate, ad performance, or revenue potential. The SDK may employ a machine-learning model to predict floor-group thresholds prior to querying the mediation platform.

According to another aspect of the present disclosure, a computer-implemented method for reducing advertisement latency is provided. The method includes receiving, by a Software Development Kit (SDK) integrated with an application executing on a device that includes a processor and a memory, an ad request for an ad placement, concurrently transmitting, by the SDK, bid requests to at least one mediation platform and to a plurality of header-bidding partners (HBPs), querying the mediation platform, by the SDK, through a plurality of floor groups until an advertisement fill is returned, identifying, by the SDK, an approximate mediation bid range by determining which floor group produced the fill, caching, by the SDK, an HBP ad object associated with a highest HBP bid and a mediation ad object returned by the mediation platform for the advertisement fill, determining, by the SDK, a maximum bid by comparing the highest HBP bid with the approximate mediation bid range, and selecting, by the SDK, for display on the device the advertisement associated with the maximum bid.

According to other aspects of the present disclosure, the computer-implemented method may include one or more of the following features. The plurality of floor groups may be dynamically generated from effective cost-per-mille (eCPM) data, and the SDK may adjust number and width of the plurality of floor groups according to historical eCPM distributions. The SDK may terminate further mediation queries once the highest HBP bid exceeds an upper bound of the approximate mediation bid range of the floor group that returned the fill. The method may further comprise determining, in real time, the highest HBP bid from the plurality of bids received from the plurality of header bidding partners.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system diagram of an Ad Request System, showing the components and interactions involved in processing ad requests and bids, in accordance with an embodiment of the present subject matter.

FIG. 2 depicts a Dynamic Floor Group System, highlighting the components for collecting data, generating floor groups, and adjusting them based on machine learning predictions, in accordance with an embodiment of the present subject matter.

FIG. 3 presents a flowchart of a process for reducing advertisement latency using an SDK integrated with a software application, in accordance with an embodiment of the present subject matter.

FIG. 4 shows a flowchart for dynamically generating floor groups based on eCPM (effective Cost Per Mille) data, in accordance with an embodiment of the present subject matter.

FIG. 5 illustrates a flowchart for optimizing mediation queries based on bid outcomes, in accordance with an embodiment of the present subject matter.

### DETAILED DESCRIPTION

Some embodiments of this disclosure, illustrating all its features, will now be discussed in detail. The words “receiving,” “initiating,” “determining,” “comparing,” “caching,” “requesting,” “submitting,” “displaying,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

When using the traditional systems, publishers are often forced to rely on sequential ad requests, also known as waterfall architecture. This approach not only delays the ad delivery but also prevents publishers from fully monetizing their available ad space. These delays, caused by waiting for each demand source to respond before moving to the next, can significantly reduce the effectiveness of the publisher's ad placements.

The present system introduces an advanced Software Development Kit (SDK) that allows publishers to integrate with multiple demand partners, including Google™, Amazon™, and other regional ad networks, in a seamless manner. This integration is designed to work with both client-side and server-side components, ensuring that ads are delivered faster and with minimal latency.

The invention further introduces an ad server, which acts as an orchestration layer. This server manages the entire auction process, ensuring that bids from multiple networks are compared and the winning bid is selected in real time. Additionally, the system includes a yield optimizer, which constantly monitors the bids and adjusts the floor price to ensure the highest possible revenue for the publisher.

The present disclosure relates to systems and methods for reducing advertisement latency in digital advertising environments. In particular, the disclosure describes a system that may optimize ad bidding processes and improve the efficiency of ad delivery.

In some cases, the system may include a device with a processor and memory executing a software application. The system may also incorporate a Software Development Kit (SDK) integrated with the software application. The SDK may be coupled to a publisher server, allowing for seamless communication between the application and the advertising infrastructure.

The system may address challenges in digital advertising by potentially reducing latency in ad delivery processes. By optimizing the interaction between various components of the advertising ecosystem, the system may enhance the speed and efficiency of ad placement.

In some implementations, the system may leverage advanced techniques to streamline the ad bidding process. These techniques may involve concurrent bid requests and intelligent caching mechanisms, which may contribute to reducing overall latency in ad delivery.

The system may also employ strategies to optimize the selection of advertisements based on various criteria. These strategies may involve comparing bids from different sources and selecting the most appropriate advertisement for display.

By potentially improving the efficiency of ad delivery and optimizing the bidding process, the system may provide benefits to both advertisers and users. Advertisers may benefit from more effective ad placement, while users may experience faster loading times and more relevant advertisements.

In traditional ad delivery systems, a waterfall architecture is commonly used, where ad requests are sequentially sent to multiple demand sources (such as ad networks) based on predefined priorities. In this architecture, an ad request is first sent to the top priority demand source, and if it does not return a valid ad, the request is sent to the next demand source in line. This process continues until an ad is returned. The primary issue with this approach is the sequential nature of the requests, which introduces significant latency into the ad-serving process.

Traditional systems do not utilize parallel processing, meaning that ad requests are handled one after the other in a slow and inefficient manner. Each additional request adds time, delaying the delivery of ads to users. Due to these delays, publishers face significant challenges in monetizing their ad inventory effectively. Ads are often not served fast enough before the user moves away from the webpage or app, causing lost ad opportunities. As a result, publishers experience a reduction in revenue since they are unable to fully capitalize on available ad placements.

The present subject matter solves the problems involved in the traditional system to increase the revenue of the publishers by reducing ad latency and improving ad fill rates. In an embodiment, the present subject matter teaches a method to avoid no-bid scenarios. In another embodiment, the present subject matter teaches a method for optimizing memory usage in a multi-layered header bidding process, wherein the method involves caching only an ad object having a highest bid.

The Ad Request System 100 comprises various components designed to optimize the process of requesting and displaying advertisements within a software application running on a user device. At the core of this system is a Software Development Kit (SDK) 102, which may be integrated with the software application to manage ad requests and bidding processes.

The SDK 102 may include several subcomponents, each serving a specific function in the ad request process. The Bid Request Manager 104 may be responsible for handling bid requests and communicating with external entities comprising header bidding partners (HBPs), a mediation platform, and a plurality of ad networks. The Cache Manager 106 may manage cached data, potentially storing bid information along with associated ad object for future use. The Bid Comparator 108 may evaluate bids from different sources to determine the most suitable advertisement for display.

In some cases, the SDK 102 may interact with external entities to facilitate the ad bidding process. These external entities may include Header Bidding Partners 110, a Mediation Platform 112, and a plurality of Ad networks (not shown). The Header Bidding Partners 110 may represent various ad networks or demand-side platforms that participate in the bidding process. The Mediation Platform 112 may serve as an intermediary, managing relationships with multiple ad networks and optimizing ad fill rates.

The Ad Request System 100 may initiate the ad request process when the SDK 102 receives an ad request for an ad placement within the software application. Upon receiving this request, the SDK 102 may retrieve ad placement details from a remote configuration. These details may include a list of applicable ad partners and their supported ad types, configuration settings for series or parallel processing, and cache handling instructions.

In some implementations, the SDK 102 may concurrently transmit bid requests to the Mediation Platform 112 and multiple Header Bidding Partners 110. This parallel approach may extend to include the plurality of ad networks as well. The simultaneous initiation of bid requests across the Mediation Platform 112, Header Bidding Partners 110, and various ad networks may potentially reduce latency in the ad selection process.

The Bid Request Manager 104 may manage these parallel bid requests, ensuring that each potential ad source receives the necessary information to participate in the bidding process. The Cache Manager 106 may store cached bid and the ad object, potentially improving response times for future ad requests. The Bid Comparator 108 may evaluate the incoming bids from various sources, comparing them to determine the most appropriate advertisement for display.

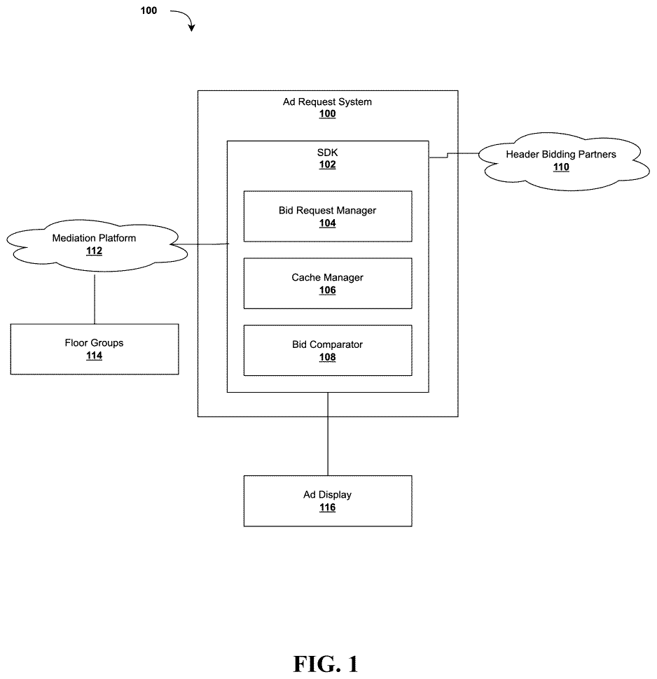

In some implementations, the SDK 102 may also communicate with a Cloud Storage (not shown in FIG. 1) that maintains historical effective cost-per-mille (eCPM) data. This data may be organized per application, ad placement, geographic region, and user cohort. The SDK 102 may upload impression-level revenue data to the Cloud Storage, thereby contributing to a cumulative dataset over time. Additionally, the SDK 102 may periodically retrieve processed summaries from the cloud, such as aggregated eCPM tables or statistical patterns, which can be used to dynamically adjust floor-group configurations.

A Machine Learning (ML) Model may be deployed to support the intelligent generation of floor-group thresholds. The ML Model may be hosted in one of two configurations: (i) as a cloud-based inference service operating in proximity to the Cloud Storage, or (ii) as an embedded, lightweight model within the SDK 102 itself. The ML Model may analyze the historical eCPM data to predict optimized floor-group thresholds for specific placements, time windows, and contexts. When hosted in the cloud, the SDK may retrieve prediction results in the form of a compact data payload, such as a JSON object containing floor-group breakpoints, at regular intervals (e.g., on application launch or based on time-based triggers).

When the ML Model is embedded within the SDK 102, inference may be performed directly on the device, leveraging previously downloaded historical eCPM data or a local cache thereof. The use of on-device inference may be particularly beneficial in low-connectivity environments or latency-sensitive scenarios. Regardless of deployment location, the output of the ML Model may be provided to the Bid Request Manager 104, enabling the SDK 102 to construct and apply dynamic floor groups when querying the mediation platform during the bidding process.

This dual-deployment capability allows flexibility for publishers and ad network operators. The cloud-hosted version of the ML Model may offer higher predictive accuracy by leveraging richer datasets and frequent retraining cycles. Meanwhile, the on-device version ensures minimal latency and offline capability. In certain implementations, the SDK 102 may also support automatic fallback mechanisms, wherein inference seamlessly switches to the on-device model if the cloud-hosted service becomes temporarily unreachable. This configuration ensures consistent and uninterrupted ad delivery performance across network conditions.

Once the bidding process is complete and an advertisement is selected, the chosen ad may be displayed on the user device through the software application integrated with the SDK 102. This display process may be managed by the Ad Display 116 component, which may receive the selected ad information from the SDK 102 (specifically Bid Comparator 108).

By leveraging this system architecture, the Ad Request System 100 may potentially optimize the ad selection process, balancing factors such as bid value, latency, and relevance to provide an efficient advertising experience within the software application.

In some cases, the Software Development Kit (SDK) may receive an ad request for an ad placement within a software application. Further, the system 100 may retrieve ad placement details from a remote configuration. The remote configuration serves as a centralized repository of information that allows for dynamic updates and flexibility in managing ad placements across various clients, applications and platforms. Further, the remote configuration eliminates the need for individual publishers to manually adjust settings or configurations across all publisher's systems, which can be prone to error and inefficiency.

As industry regulations and platform updates evolve, the remote configuration ensures that publishers can quickly adapt without the need for extensive reconfigurations. This is crucial in maintaining compliance with tightening privacy regulations and keeping pace with industry leaders like Google™ and Meta™. By dynamically managing ad placements and partner integrations, the remote configuration helps ensure that ad servers are optimized for better performance, reducing inefficiencies and improving ad delivery speed.

Upon receiving the ad request, the system retrieves the ad placement details. The ad placement details comprise a list of applicable ad partners and their supported ad types, configuration settings for series or parallel processing, and cache handling instructions.

The list of applicable ad partners included in the ad placement details enables the system to target specific partners that are relevant to the particular ad placement. This targeted approach ensures that only appropriate ad partners are contacted, optimizing the bidding process and potentially improving the quality and relevance of the ads displayed. The supported ad types for each partner are also specified, allowing the system to filter and match ad requests with compatible ad formats, thereby reducing the likelihood of incompatible ad serving.

The configuration settings for series or parallel processing provide the system with instructions on how to execute the ad request workflow. Parallel processing allows for simultaneous bid requests to multiple partners, potentially reducing overall latency. In certain embodiments, series processing to deliver the ad may be preferred.

Further, the cache handling instructions guide the system on how to manage ad objects and bid information. It may be noted that the caching reduces ad delivery time by storing frequently used or recently retrieved ad data. The system can use these instructions to determine what information to cache, how long to retain it, and when to invalidate or refresh the cache, thus optimizing the trade-off between data freshness and response time.

By utilizing the ad placement details, the system can make informed decisions throughout the ad serving process, from partner selection and bid management to ad delivery and caching strategies, ultimately aiming to optimize advertisement yield and reduce latency.

Further to receiving the ad request, the SDK may initiate concurrent bid requests to both a mediation platform and multiple header-bidding partners (HBPs). This parallel approach to bid requests may potentially reduce latency in the ad selection process. In an embodiment, the SDK may initiate concurrent bid requests to a plurality of ad networks.

The system utilizes a parallel request processing architecture for sending the ad request to all partners in a single hop.

The parallel request processing architecture is designed to optimize ad yield and minimize latency by simultaneously initiating bid requests to multiple partners. This approach allows for efficient gathering of competitive bids from various sources without introducing unnecessary delays.

When an ad request is received, the system immediately triggers parallel bid requests to three main categories of partners:
1. Mediation Platform: A call is made to a primary mediation platform without delay. The mediation platform sends the ad request to one or more demand partners that are linked to the mediation platform. In an embodiment, the system may make a call to one or more mediation platform at once.
2. Header Bidding Partners: Concurrent bid requests are sent to all applicable header bidding partners. The header bidding partners participate in real-time auctions, submitting their bids for the ad placement. The system collects these bids as they arrive, allowing for a dynamic and competitive bidding process.
3. Ad Networks: Simultaneously, bid requests are dispatched to various ad networks. These networks may not always provide real-time bids but are crucial for ensuring fill rates and can serve as backfill options in a waterfall architecture.

The parallel architecture ensures that the system doesn't wait for responses from one partner before proceeding to the next. This simultaneous approach significantly reduces the overall time required to collect bids from all potential sources. By initiating these requests in parallel, the system can effectively manage timeouts and handle varying response times from different partners without compromising the ad serving process.

The ad networks serve as a safety net in the waterfall architecture, ensuring that an ad can still be served even if real-time header bidding partners fail to provide suitable bids. This approach maximizes the chances of filling the ad placement while maintaining the efficiency of the parallel processing model.

Further to initiating the parallel bid request, the system determines, in real time, a highest HBP bid from a plurality of bids received from the plurality of header bidding partners. The highest HBP bid is a winning bid amongst the plurality of bids received from the plurality of header bidding partners. The real-time determination of the highest bid is important for maximizing revenue potential while maintaining efficiency of an ad delivery. As the system receives bids from various header bidding partners, the system continuously evaluates and compares the received bids to identify the highest HBP bid. It may be noted that the highest HBP bid determination process occurs simultaneously with other operations, such as the mediation platform's bid collection, to minimize overall latency.

The highest HBP bid serves as a benchmark for comparison with bids from other sources, including the mediation platform and the plurality of ad networks. Further, the system may set the highest HBP bid as a floor price when comparing with an approximate mediation bid range by determining which floor group of the mediation platform produced the fill.

In another embodiment, the system may be integrated with one or more header bidding platforms wherein each header bidding platform comprises a plurality of header bidding partners. Further, each header bidding platform submits a highest bid to the system. Further, the system determines highest bid amongst the one or more header bidding platforms. Let's assume that the system is integrated with one or more header bidding platforms named as ABC, PQR, and XYZ. Each header bidding platform (ABC, PQR, and XYZ) conducts a bidding process internally and submits the highest bid to the system. Let's assume that the highest bid from ABC is $15, PQR is $12, and XYZ is $14. The system then determines that the highest bid is received from ABC and then the system automatically sends a request to the ABC header bidding platform to share an ad object. The ABC header bidding platform fetches the ad object from a winning header bidder partner and shares the ad object with the system.

In some implementations, the SDK may query the mediation platform through multiple floor groups. These floor groups may represent different bid ranges, typically arranged from highest to lowest. The SDK may employ a top-to-bottom approach when querying these mediation groups, starting with the highest group and moving downwards to check for better bids.

In some cases, the system may dynamically generate floor groups based on effective cost-per-mille (eCPM) data. This process may involve analyzing historical eCPM distributions to adjust the number and width of floor groups, potentially optimizing the ad bidding process.

Here's an example of how the system may create 5 floor groups based on received eCPM data:

The system may receive historical eCPM data for a particular ad placement over the past 30 days. After analyzing this data, the system may determine that the eCPM values typically range from $1 to $20. Based on this information, the system may create the following 5 floor groups:
1. Group A: $16-$20
2. Group B: $11-$15.99
3. Group C: $6-$10.99
4. Group D: $3-$5.99
5. Group E: $1-$2.99

The system may adjust these floor groups dynamically based on ongoing eCPM data analysis. For instance, if the system observes a shift in eCPM trends, it may modify the group ranges accordingly. The number of groups and their ranges may be optimized to balance granularity and efficiency in the bidding process.

In some cases, the system may create non-uniform group ranges to better reflect the distribution of bids. For example, if there is a higher concentration of bids in the lower ranges, the system may create narrower groups at the lower end and wider groups at the higher end.

In another example, the system may receive a highest bid of $5 from the Header Bidding Partners (HBPs). To optimize the bidding process, the system may create floor groups that converge near this HBP bid. This approach may allow for more granular comparisons around the known competitive bid price. The system may generate the following floor groups:
1. Group A: $7.00 and above
2. Group B: $6.00-$6.99
3. Group C: $5.50-$5.99
4. Group D: $5.25-$5.49
5. Group E: $5.00-$5.24
6. Group F: $4.75-$4.99
7. Group G: $4.50-$4.74
8. Group H: $4.00-$4.49
9. Group I: $3.00-$3.99
10. Group J: Below $3.00

In this configuration, the system creates more narrowly defined groups around the $5 HBP bid, allowing for finer granularity in bid comparisons near this price point. The groups become wider as they move away from the HBP bid, reflecting decreased need for precision at those price levels. This approach may enable the system to more efficiently query the mediation platform and compare bids, potentially reducing the number of queries required to find the optimal bid

As the SDK queries each floor group, the system may continue this process until an advertisement fill is returned. This approach may allow the system to efficiently identify the highest available bid from the mediation platform.

In some cases, the system may stop querying lower groups from the mediation platform if the highest HBP bid exceeds the current group being queried. This optimization may help reduce unnecessary queries and potentially improve the efficiency of the bidding process.

By determining which floor group produced the fill, the SDK may identify an approximate mediation bid range. This information may be useful for comparing the mediation platform's bid with the highest HBP bid.

Further to determining the highest HBP bid and identifying an approximate mediation bid range by determining which floor group produced the fill, the SDK may cache both (i) the ad object associated with the highest HBP bid and (ii) the ad object returned by the mediation platform for the advertisement fill. In an embodiment, the caching is not performed simultaneously; rather, it occurs incrementally as responses are received from each source. For instance, when a header-bidding partner returns a bid, the SDK may immediately cache the bid value along with its associated ad object. Similarly, when the mediation platform returns an advertisement fill, the SDK may then cache the corresponding mediation ad object. This stepwise caching process allows the system to prepare both ad options in parallel with bid evaluation, enabling immediate retrieval of the selected advertisement once the comparison is complete. The cached bid values and ad objects may be stored in volatile memory, such as, but not limited to, RAM, ensuring low-latency access and reducing the time required to render the final ad upon selection.

In some implementations, if the HBP's ad object is received first, the system may cache this object. This caching strategy may ensure that the ad is ready to be displayed immediately if no higher bid or no bid is found later, potentially reducing latency in ad delivery.

The process of querying through floor groups and caching bid information may allow the system to efficiently determine a maximum bid by comparing the highest HBP bid with the approximate mediation bid range. In some implementations, the SDK may infer the mediation bid range by identifying which floor group returned the fill, where each floor group represents a bounded bid range—e.g., $4.00-$4.50 or $6.00-$6.50. The SDK may compare the known value of the highest HBP bid against either the lower bound, upper bound, or a derived esminimize impression latency while maximizing yield, ensuring a smooth and revenue-optimized comparison may be governed by a configurable policy set by the publisher or ad network operator, ensuring deterministic and context-specific ad selection.

Once the maximum bid is determined—i.e., the SDK identifies whether the HBP bid or the mediation bid range reflects the higher value—the SDK may select the advertisement associated with that maximum bid for display on the device. Since both ad objects (HBP and mediation) have already been cached in volatile memory, the SDK may immediately retrieve and render the winning ad without additional network latency. This real-time decisioning flow, which blends pre-cached content with intelligent bid comparison, allows the system to minimize impression latency while maximizing yield, ensuring a smooth and revenue-optimized ad experience for the user.

In some cases, the Software Development Kit (SDK) may compare the highest HBP bid with the approximate mediation bid range identified through the floor group querying process. This comparison may allow the system to determine which source has provided the maximum bid for the ad placement.

The SDK may identify the approximate mediation bid range by determining which floor group produced the advertisement fill. Since each floor group may represent a specific bid range, the system may use this information to infer the approximate value of the mediation platform's bid. This approach may provide a basis for comparison with the highest HBP bid without requiring exact bid values from the mediation platform.

In some implementations, the SDK may perform a direct comparison between the highest HBP bid and the lower bound of the floor group that produced the fill from the mediation platform. If the HBP bid exceeds this lower bound, the system may consider the HBP bid to be higher or maximum. Conversely, if the HBP bid falls below the lower bound of the floor group, the system may consider the mediation platform's bid to be higher.

In another implementation, if the HBP bid exceeds an upper bound of the floor group, the system may consider the HBP bid to be higher. Conversely, if the HBP bid falls below the upper bound of the floor group, the system may consider the mediation platform's bid to be higher.

In an embodiment, the SDK exposes a configurable policy flag that allows the client software application to specify how competing bids are evaluated when the mediation platform returns only a bid range (e.g., US $4.95-US $5.40). During integration, the publisher (or its ad-ops console) may set this flag to one of several comparison rules. The SDK then applies the selected rule consistently at runtime, ensuring deterministic ad selection while still permitting publishers to tune for revenue-versus-fill-rate trade-offs.

| | Comparison Test | Example with B = | |
|---|---|---|---|
| Rule | (HBP bid = B, floor- | US $5.00, range = | |
| (Embodiment) | group range = [L, U]) | US $4.95-5.40 | Outcome Rationale |
| Lower-Bound | If B ≥ L, select HBP; | 5.00 ≥ 4.95 → HBP | Captures incremental |
| Rule | else select mediation. | wins | revenue whenever the |
| | | | mediation clear price may |
| | | | be near the floor. |
| Upper-Bound | If B > U, select HBP; | 5.00 > 5.40 → | Ensures the mediation |
| Rule | else select mediation. | Mediation wins | partner is never bypassed |
| | | | when its bid might exceed |
| | | | the HBP. |
| Mid-Point/ML- | Compute estimate E | Mid-point E ≈ 5.18; | Balances risk by using a |
| Estimate Rule | inside [L, U]; if B ≥ E, | 5.00 < 5.18 → | predictive value; E can be |
| | select HBP. | Mediation wins | static midpoint or ML- |
| | | | predicted. |
| Inclusive Tie- | If L ≤ B ≤ U, select | 4.95 ≤ 5.00 ≤ 5.40 → | Resolves equal-price |
| Break Rule | HBP; else apply | HBP wins | scenarios in favor of the |
| | chosen bound test. | | HBP to minimize latency. |

Upon startup—or on a configuration refresh—the SDK downloads the publisher-selected rule, stores it in a lightweight cache, and applies it to every comparison between the highest header-bidding-partner bid and the inferred mediation bid range. This architecture permits per-placement tuning without altering the core decision pipeline, supporting both conservative (upper-bound) and aggressive (lower-bound) revenue strategies within the same deployment.

The SDK may use the results of this comparison to select the advertisement associated with the higher bid for display on the device. In cases where the HBP bid is determined to be higher, the SDK may retrieve the cached ad object associated with that bid. If the mediation platform's bid is higher, the SDK may request the corresponding advertisement from the mediation platform.

In some embodiments, the SDK may implement additional logic to handle scenarios where the bids are very close or fall within the same floor group range. For example, the system may consider factors such as ad relevance, user preferences, or historical performance data to make a final selection when bid values are similar.

By comparing bids and selecting the advertisement associated with the higher bid, the SDK may aim to maximize the value of each ad placement while potentially improving the overall efficiency of the ad delivery process. This approach may benefit both advertisers and publishers by potentially increasing revenue and ensuring that the most competitive ads are displayed to users.

Consider an example, the system is used for displaying ads in a mobile game application. When a user reaches a natural break point in the game, the app triggers an ad request for an interstitial video ad placement.

The system receives this ad request and immediately initiates parallel bid requests to:

| Mediation Platform | Header Bidding Partners |
|---|---|
| Google Ad Manager ™ | Amazon Hub Centre ™ |
| Google AdMob ™ | Nimbus ™ |
| AppLovin ™ | Liftoff ™ |

As responses come in, the system processes the responses in real-time:

Let's assume that Amazon Hub Centre™ returns a bid of $10 Cost Per Mille (CPM), Nimbus™ returns a bid of $12 CPM, and Liftoff™ returns a bid of $8. Based on the received bids, the system determines that Nimbus™ has the highest bid among header bidding partners at $12 CPM. The system requests and caches Nimbus's ad object in volatile memory.

Simultaneously, the system queries Google Ad Manager™, Google AdMob™, and AppLovin™ through multiple floor groups. The system starts with the highest floor group ($15-$20) and proceeds downward. When querying the $8-$10 floor group, Google Ad Manager™ returns an ad fill while no ad fill is received form other mediation partners.

The system then compares Nimbus's $12 CPM bid with Google Ad Manager's approximate bid range of $8-$10. Using the configured comparison rule, the system determines that Nimbus's bid is higher.

Since Nimbus's bid is higher, the system selects Nimbus's cached ad object for display. The ad is immediately shown to the user with minimal latency, as the ad object was already cached in volatile memory during the bidding process. The entire process from initial ad request to display takes less than 200 milliseconds, significantly faster than traditional sequential waterfall approaches that might take 500-1000 milliseconds.

The system records this bid outcome in its historical data storage, which will be used to optimize future floor groups and bidding strategies. Over time, the machine learning model may adjust floor group thresholds based on observed patterns, potentially creating narrower ranges around the $12 price point where competitive bidding frequently occurs for this particular ad placement.

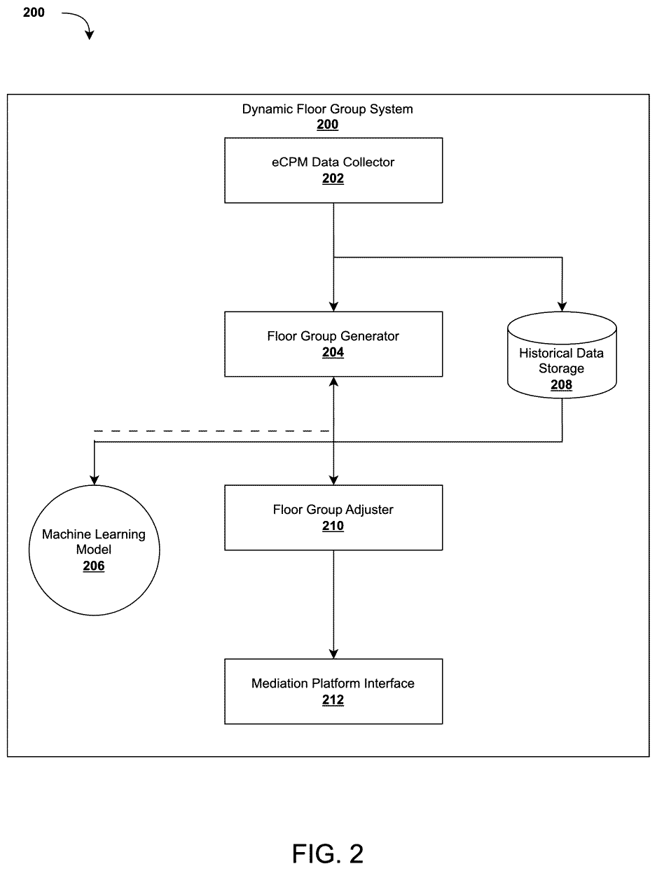

FIG. 2 illustrates a Dynamic Floor Group System 200 that continuously refines bid floors for each application or ad placement. At the heart of the system is an eCPM Data Collector 202, which ingests impression-level revenue data-immediately tagging each record with the relevant app-ID, placement-ID, geo, and other context. These fine-grained observations are streamed to a Historical Data Storage 208 on the server, creating a time-ordered repository of past eCPM values. Storing this history centrally, rather than in the SDK, keeps the on-device footprint small and allows the backend to aggregate months of data for trend analysis and model training.

A Floor Group Generator 204 runs on the backend against this historical store. At configurable intervals (for example, hourly), it computes fresh floor groups for every placement. The generator first establishes a base bid value—typically the median or 60th-percentile eCPM for that placement—and then shapes the bands around it. Where bids are densely clustered near the base, the generator carves out narrowly spaced ranges (e.g., US $5.00-5.10, US $5.10-5.20). Conversely, for sparsely populated upper tails, it widens the bands (e.g., US $9.00-10.00, US $10.00-12.50) so that each group still receives meaningful traffic.

Once generated, the updated floor-group table—essentially a compact JSON payload—is pushed to the SDK, which caches only the current thresholds required for real-time decisioning. If the device is offline, the SDK simply falls back to the last-synced table until connectivity is restored. This hybrid design marries server-side depth (full history, advanced analytics, and ML tuning) with client-side speed, ensuring the system always evaluates incoming bids against the most revenue-optimal, placement-specific floor groups.

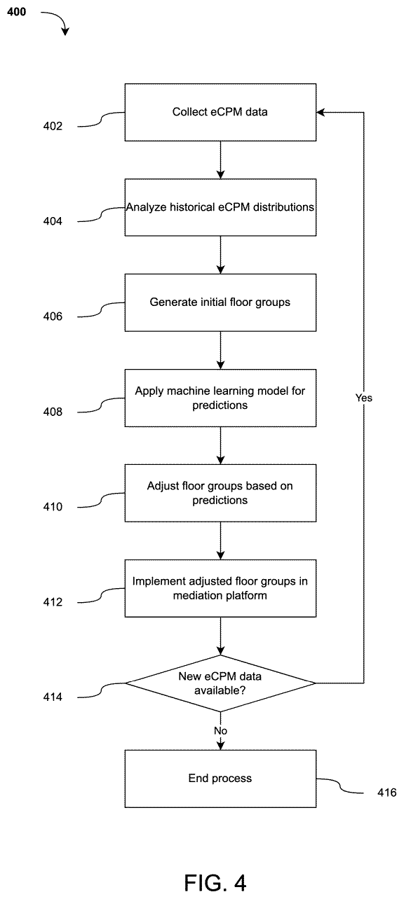

FIG. 4 depicts a flowchart that may represent the process of dynamically generating floor groups. The process may begin with collecting eCPM data (step 400) and analyzing historical eCPM distributions (step 402). Based on this analysis, initial floor groups may be generated (step 404).

In some implementations, the system may employ a Machine Learning Model 206 to predict floor-group thresholds. This model may analyze patterns in the historical eCPM data to suggest optimal groupings. The predictions from the Machine Learning Model 206 may be applied (step 406) to adjust the floor groups (step 408).

The Floor Group Adjuster 210 may refine the generated floor groups based on the machine learning predictions and other factors. This adjustment process may involve modifying the number and width of floor groups to better reflect current market conditions and historical trends.

In some cases, the system may create more granular floor groups in areas where bids are densely clustered. For instance, if the eCPM data indicates that many bids fall within a narrow range near a certain value, the system may create smaller, more precise floor groups in that area. Conversely, for higher ranges where bids may be less common, the system may establish wider floor groups to reduce unnecessary calls to the mediation platform.

The adjusted floor groups may then be implemented in the mediation platform (step 410). This implementation may allow for more efficient querying of the mediation platform during the ad bidding process.

The system may continuously update and refine the floor groups as new eCPM data becomes available. As shown in FIG. 4, the process may loop back to the data collection step (step 400) when new data is available (step 412), allowing for ongoing optimization of the floor groups.

By dynamically generating and adjusting floor groups based on eCPM data, the system may potentially improve the efficiency of the ad bidding process. This approach may allow for more accurate bid comparisons and may help optimize the selection of advertisements for display.

In some cases, the system may employ a machine-learning model to predict floor-group thresholds prior to querying the mediation platform. This approach may enhance the efficiency of the ad bidding process by optimizing the structure of floor groups based on historical data and current market trends.

FIG. 2 illustrates a Dynamic Floor Group System 200 that may incorporate a Machine Learning Model 206. This model may be designed to analyze patterns in historical eCPM (effective Cost Per Mille) data and generate predictions for optimal floor-group thresholds.

The process of integrating machine learning into the floor group generation may begin with data collection. As shown in FIG. 4, the system may collect eCPM data (step 400) from various sources. This data may be stored in a Historical Data Storage 208, as depicted in FIG. 2, providing a comprehensive dataset for analysis.

In some cases, the system may analyze historical eCPM distributions (step 402) to identify patterns and trends in ad pricing. This analysis may involve examining factors such as seasonal variations, time-of-day effects, and long-term pricing trends across different ad categories or placements.

The Machine Learning Model 206 may use this analyzed data to generate predictions for floor-group thresholds. These predictions may be applied (step 406) to adjust the initial floor groups generated by the system. The model may consider various factors when making predictions, such as:
1. Historical bid patterns
2. Time-based trends
3. Ad category performance
4. User engagement metrics
5. Advertiser behavior

By incorporating these factors, the machine learning model may generate more accurate and dynamic predictions for floor-group thresholds. These predictions may help optimize the structure of floor groups, potentially improving the efficiency of the ad bidding process.

In some implementations, the system may continuously update and refine the machine learning model as new data becomes available. This ongoing learning process may allow the model to adapt to changing market conditions and improve its predictive accuracy over time.

The integration of machine learning into the floor group generation process may offer several potential benefits:
1. More accurate floor-group thresholds
2. Improved ad revenue optimization
3. Reduced latency in the bidding process
4. Better adaptation to market fluctuations

By employing a machine-learning model to predict floor-group thresholds, the system may enhance its ability to efficiently query the mediation platform and optimize the ad selection process. This approach may contribute to a more effective and responsive ad delivery system, potentially benefiting both publishers and advertisers.

In some cases, the system may employ various optimization techniques to enhance the efficiency of the ad bidding process. These techniques may include recording bid outcomes, bypassing certain mediation partners, and terminating mediation queries under specific conditions.

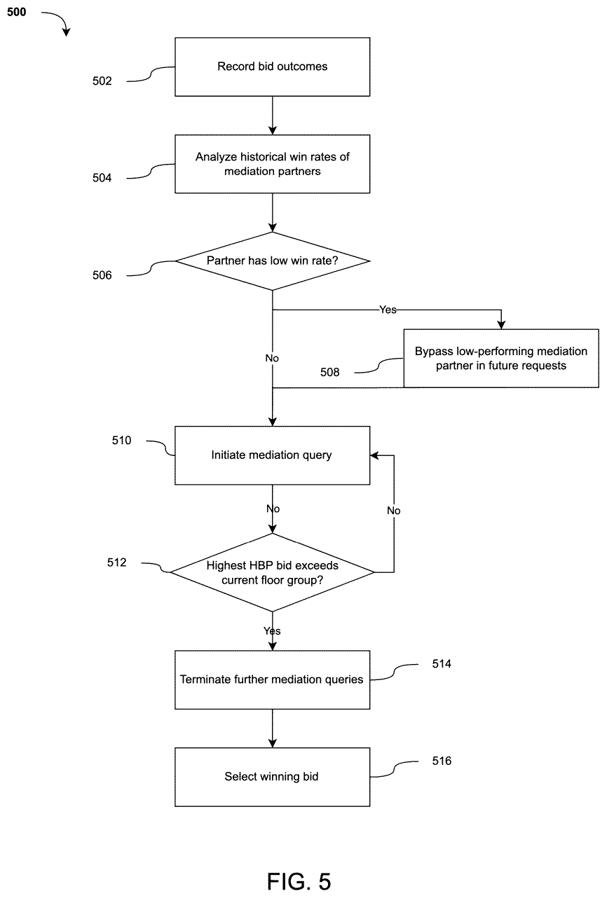

FIG. 5 illustrates a flowchart that may represent the process of optimizing mediation queries based on bid outcomes. The process may begin with recording bid outcomes (step 500). This step may involve collecting data on the performance of various mediation partners and header bidding partners (HBPs) over time.

In some implementations, the system may analyze historical win rates of mediation partners (step 502). This analysis may help identify partners that consistently underperform in the bidding process. Based on this analysis, the system may determine if a partner has a low win rate (step 504).

In some cases, if a mediation partner is found to have a historically low win rate, the system may bypass that partner in future ad requests (step 506). This optimization technique may help reduce unnecessary queries to partners that are unlikely to provide competitive bids, potentially improving the overall efficiency of the ad request process.

The system may initiate a mediation query (step 508) to partners that have not been bypassed. During this process, the system may compare the highest bid from header bidding partners (HBPs) with the current floor group being queried in the mediation platform.

In some implementations, the system may terminate further mediation queries once the highest HBP bid exceeds an upper bound of the bid range of the floor group that returned the fill (step 512). This optimization technique may help reduce unnecessary queries to lower floor groups when a sufficiently high bid has already been received, potentially reducing latency in the ad selection process.

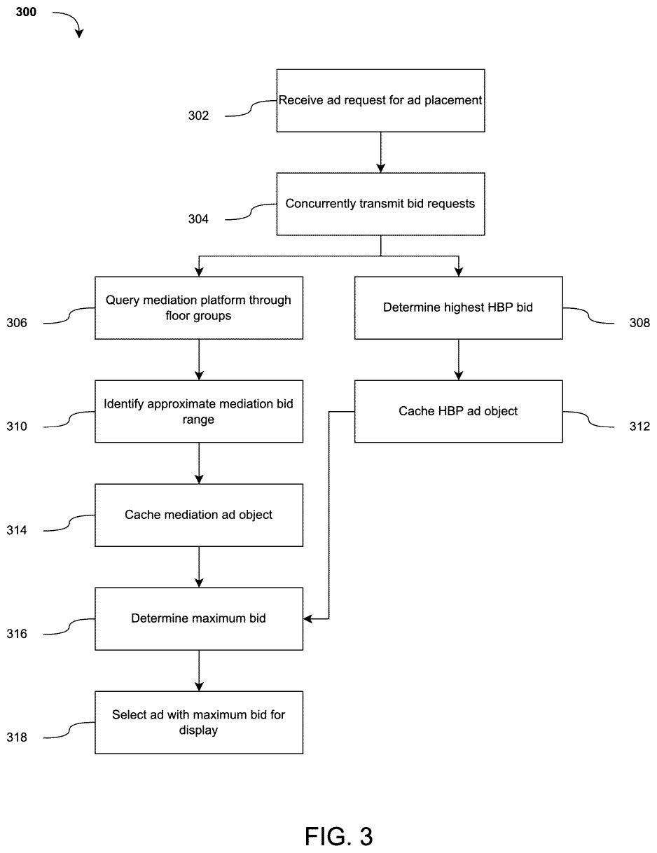

FIG. 3 illustrates a flowchart of a method 300 for processing advertisement requests and selecting advertisements for display. The method 300 begins with receiving an ad request for ad placement (step 302) and concurrently transmitting bid requests to potential advertisers (step 304). The method then proceeds along two parallel paths. In one path, the method queries a mediation platform through floor groups (step 306), identifies an approximate mediation bid range (step 310), and caches the mediation ad object (step 314). Simultaneously, in the parallel path, the method determines the highest HBP bid (step 308) and caches the HBP ad object (step 312). The paths converge at step 316, where the method determines the maximum bid by comparing the results from both paths. Finally, the method selects the ad with the maximum bid for display (step 318). This flowchart demonstrates how the method 300 processes bids from different sources in parallel and uses caching mechanisms to store ad objects before making a final selection based on bid amounts. This process may incorporate various optimization techniques, including those described in FIG. 5.

In some cases, the system may utilize backfill ad networks when the primary ad sources (header bidding partners and mediation platform) fail to provide a suitable ad. The system may prioritize these backfill ad networks based on predefined criteria, such as historical fill rates, ad performance, or revenue potential. This prioritization may help optimize ad selection in scenarios where the primary sources are unable to provide an ad or a winning bid.

In some implementations, the system may dynamically adjust the positioning of backfill ad networks in waterfall architecture. This adjustment may be based on real-time data, including ad inventory availability and user engagement metrics. By continuously refining the order of backfill networks, the system may potentially improve the chances of filling ad requests efficiently when primary sources are unavailable.

These optimization techniques may work together to potentially enhance the overall performance of the ad request system. By recording and analyzing bid outcomes, bypassing underperforming partners, terminating unnecessary queries, and dynamically managing backfill networks, the system may aim to reduce latency and improve the efficiency of the ad selection process.

In some cases, the system may employ various caching mechanisms to reduce latency in the ad delivery process. These mechanisms may involve caching the highest bid and its associated ad object, as well as implementing strategies to minimize network traffic during ad impressions.

The Software Development Kit (SDK) may cache the highest bid received from header bidding partners along with its associated ad object. This caching process may be performed in volatile memory, allowing for immediate retrieval of the ad object when requested by the mediation platform. By storing this information in readily accessible memory, the system may potentially reduce the time required to retrieve and display the advertisement if it is ultimately selected.

In some implementations, the SDK may transmit only an advertisement identifier to the device while retaining the ad object in cache. This approach may help reduce network latency on impression by minimizing the amount of data transferred between the SDK and the device. Instead of sending the entire ad object, which may be relatively large, the SDK may send a smaller identifier that can be used to retrieve the cached ad object when needed.

The system may determine a cache hit by checking if the ad object associated with the highest bid is already stored in the cache. In some cases, if a cache hit occurs, the system may retrieve and display the cached ad object without initiating a new ad request to the header bidding partners or the mediation platform. This process may potentially reduce latency by eliminating the need for additional network requests and bid processing.

By leveraging these caching mechanisms, the system may aim to optimize the ad delivery process and reduce overall latency. Caching the highest bid and its associated ad object may allow for quicker decision-making and ad display, while transmitting only an advertisement identifier may help minimize network traffic. Additionally, utilizing cache hits may potentially eliminate unnecessary ad requests, further contributing to latency reduction in the ad serving process.

In some cases, the system may integrate with various ad networks to enhance the ad selection process and ensure ad placement even when primary sources fail to provide suitable bids. This integration may involve initiating parallel bid requests and utilizing ad networks as backfill through waterfall architecture when necessary.

The system may initiate parallel bid requests to multiple ad networks alongside the requests sent to header bidding partners and the mediation platform. This concurrent approach may potentially reduce overall latency in the ad selection process by allowing multiple sources to compete simultaneously for the ad placement.

In some implementations, the ad networks integrated with the system may not submit real-time bids. Instead, these networks may provide pre-negotiated rates or historical performance data that the system may use to determine their position in the ad selection process.

The system may utilize the ad networks as backfill to fill the ad placement through waterfall architecture. This approach may be employed when the system fails to receive suitable bids from the header bidding partners and mediation platform. The waterfall architecture may involve sequentially querying ad networks in a predetermined order until an acceptable ad is found.

In some cases, the system may prioritize the backfill ad networks based on various criteria. These criteria may include historical fill rates, ad performance metrics, or potential revenue generation. By prioritizing the networks, the system may aim to optimize ad selection when primary sources are unable to provide a winning bid or an ad that meets specific threshold requirements.

The system may dynamically adjust the positioning of backfill ad networks within the waterfall architecture. This adjustment may be based on real-time data, such as current ad inventory availability or user engagement metrics. By continuously refining the order of backfill networks, the system may potentially improve the efficiency of filling ad requests when primary sources are unavailable.

In some implementations, the system may employ different strategies for integrating ad networks based on the specific requirements of the ad placement. For example, certain ad placements may prioritize speed over bid value, while others may focus on maximizing revenue. The system may adjust its integration approach accordingly to meet these varying needs.

By integrating with multiple ad networks and utilizing them as backfill through waterfall architecture, the system may aim to ensure that ad placements are filled even when primary sources fail to provide suitable bids. This approach may potentially enhance the overall effectiveness of the ad selection process and help maximize ad fill rates.

In some cases, the system for reducing advertisement latency may incorporate various features and mechanisms to potentially enhance the efficiency of ad delivery and selection processes. The system may employ concurrent bid requests to multiple sources, including header bidding partners, mediation platforms, and ad networks. This parallel approach to bid requests may contribute to reducing overall latency in the ad selection process.

The system may utilize dynamic floor groups based on effective cost-per-mille (eCPM) data. By analyzing historical eCPM distributions and employing machine learning models, the system may adjust the number and width of floor groups. This dynamic approach may allow for more efficient querying of mediation platforms and potentially improve bid comparison accuracy.

In some implementations, the system may employ caching mechanisms to store high bids and associated ad objects. This caching strategy may allow for quicker retrieval and display of advertisements, potentially reducing latency on impression. The system may also transmit only advertisement identifiers while retaining ad objects in cache, which may help minimize network traffic during ad delivery.

The system may incorporate optimization techniques such as recording bid outcomes and bypassing underperforming mediation partners. By analyzing historical win rates, the system may streamline the query process and focus on partners more likely to provide competitive bids. Additionally, the system may terminate further mediation queries when certain conditions are met, potentially reducing unnecessary network requests.

In some cases, the system may utilize backfill ad networks through waterfall architecture when primary sources fail to provide suitable bids. The system may prioritize and dynamically adjust the positioning of these backfill networks based on various criteria and real-time data. This approach may help ensure ad placements are filled even when primary sources are unavailable.

By combining these various features and mechanisms, the system may aim to create a comprehensive approach to ad selection and delivery. This approach may potentially lead to reduced latency, improved efficiency in the bidding process, and optimized ad selection across multiple platforms and partners.

FIG. 2 illustrates a Dynamic Floor Group System 200 incorporating a Machine Learning Model 206 designed to optimize floor-group threshold predictions by analyzing historical effective Cost Per Mille (eCPM) data. The model's primary objective is to detect patterns and trends within the eCPM data to dynamically adjust floor groups for better ad bidding efficiency and revenue maximization.

The machine learning training process begins with the collection of comprehensive eCPM datasets from diverse sources, as shown in FIG. 4 (step 400). This data is securely stored in the Historical Data Storage 208, creating a rich repository of past bidding information. The collected data spans multiple dimensions such as time, ad category, geographic location, and user engagement metrics, providing a multidimensional input set for model training.

During training, the model analyzes historical eCPM distributions (step 402), focusing on key factors such as seasonal variations, time-of-day effects, advertiser bidding behavior, and ad category performance. This phase leverages statistical feature extraction to identify relevant trends, which serve as predictive indicators for adjusting floor-group thresholds. The model continuously refines its understanding by correlating bid success rates with these features, improving its accuracy in predicting optimal threshold values.

A supervised learning approach is preferred, with regression models such as Gradient Boosted Trees or Random Forest Regressors well-suited for this application due to their robustness in handling nonlinear relationships and heterogeneous data. Alternatively, deep learning models, like feedforward neural networks, may be employed for larger datasets to capture complex feature interactions. The model is trained to minimize prediction error on floor-group boundaries, enabling the system to set dynamic, data-driven floor groups that enhance bidding efficiency.

Once trained, the Machine Learning Model 206 generates predicted floor-group thresholds (step 406) that dynamically adjust the initial floor groups. The system applies these predictions in real-time to refine the bidding process, enabling efficient mediation platform queries. The model undergoes continuous retraining as new eCPM data arrives, ensuring adaptability to market fluctuations and emerging trends, thereby maintaining optimal floor-group configurations and improving overall ad revenue performance.

A number of implementations have been described. Nevertheless, it will be understood that various modifications may be made without departing from the spirit and scope of the disclosure. Accordingly, other implementations are within the scope of the following claims.

1. A system for reducing advertisement latency, comprising:
a device including a processor and a memory executing an application; and
a Software Development Kit (SDK) integrated with the application, stored in the memory and executed by the processor, the SDK being coupled to a publisher server and configured to:
receive an ad request for an ad placement;
concurrently transmit bid requests to at least one mediation platform and to a plurality of header-bidding partners (HBPs);
query the mediation platform through a plurality of floor groups until an advertisement fill is returned;
identify an approximate mediation bid range by determining which floor group produced the fill;
cache an HBP ad object associated with a highest HBP bid and a mediation ad object returned by the mediation platform for the advertisement fill;
determine a maximum bid by comparing the highest HBP bid with the approximate mediation bid range; and
select for display on the device the advertisement associated with the maximum bid.

2. The system of claim 1, wherein the plurality of floor groups is dynamically generated from effective cost-per-mille (eCPM) data.

3. The system of claim 2, wherein the SDK adjusts number and width of the plurality of floor groups according to historical eCPM distributions.

4. The system of claim 1, wherein the SDK terminates further mediation queries once the highest HBP bid exceeds an upper bound of the approximate mediation bid range of the floor group that returned the fill.

5. The system of claim 1, wherein the SDK records bid outcomes and bypasses mediation partners with historically low win rates in subsequent ad requests.

6. The system of claim 1, further comprising determining, in real time, the highest HBP bid from the plurality of bids received from the plurality of header bidding partners.

7. The system of claim 8, wherein the maximum bid is a winning bid amongst the plurality of bids from the plurality of header bidding partners and the one or more mediation partners.

8. The system of claim 1, wherein the concurrent bid requests are additionally transmitted to a plurality of ad networks separate from the plurality of header-bidding partners and the at least one mediation platform.

9. The system of claim 1, further comprising retrieving ad placement details from a remote configuration, and wherein the ad placement details comprise a list of applicable ad partners and their supported ad types, configuration settings for at least one of series processing and parallel processing, and cache handling instructions.

10. The system of claim 1, wherein the caching of the mediation ad object and its approximate mediation bid range, and the HBP ad object and the highest HBP bid is performed in volatile memory for immediately retrieving the ad object.

11. The system of claim 1, wherein the parallel bid requests are initiated simultaneously across the mediation platform, header bidding partners, and a plurality of ad networks.

12. The system of claim 1, further comprising detecting a cache hit by determining whether the ad object associated with the maximum bid is already stored in the cache and, in response to the cache hit, retrieving and displaying the cached ad object.

13. The system of claim 1, further comprising utilizing the plurality of ad networks as backfill to fill the ad placement through waterfall architecture upon failure to receive bids from the plurality of header bidding partners and at least one mediation platform.

14. The system of claim 1, further comprises prioritizing backfill ad networks based on predefined criteria, such as historical fill rates, ad performance, or revenue potential, to optimize ad selection when the plurality of header bidding partners and mediation platform fail to provide an ad or a winning bid or an ad with a bid higher than a threshold ad bid decided by a client.

15. The system of claim 1, wherein the backfill ad networks are prioritized according to predefined criteria that include at least one of historical fill rate, ad performance, or revenue potential.

16. The system of claim 2, wherein the SDK employs a machine-learning model to predict floor-group thresholds prior to querying the mediation platform.

17. A computer-implemented method for reducing advertisement latency, comprising:
receiving, by a Software Development Kit (SDK) integrated with an application executing on a device that includes a processor and a memory, an ad request for an ad placement;
concurrently transmitting, by the SDK, bid requests to at least one mediation platform and to a plurality of header-bidding partners (HBPs);
querying the mediation platform, by the SDK, through a plurality of floor groups until an advertisement fill is returned;
identifying, by the SDK, an approximate mediation bid range by determining which floor group produced the fill;
caching, by the SDK, an HBP ad object associated with a highest HBP bid and a mediation ad object returned by the mediation platform for the advertisement fill;
determining, by the SDK, a maximum bid by comparing the highest HBP bid with the approximate mediation bid range; and
selecting, by the SDK, for display on the device the advertisement associated with the maximum bid.

18. The computer-implemented method of claim 17, wherein the plurality of floor groups is dynamically generated from effective cost-per-mille (eCPM) data, and wherein the SDK adjusts number and width of the plurality of floor groups according to historical eCPM distributions.

19. The computer-implemented method of claim 17, wherein the SDK terminates further mediation queries once the highest HBP bid exceeds an upper bound of the approximate mediation bid range of the floor group that returned the fill.

20. The computer-implemented method of claim 17, further comprising determining, in real time, the highest HBP bid from the plurality of bids received from the plurality of header bidding partners.
